(19) United States
(12) Patent Application Publication
(10) Pub. No.: US 2016/0082629 A1
(43) Pub. Date: Mar. 24, 2016

(54) OVERMOULDING PROCESS HAVING INTERMEDIATE HEATING STEP

(71) Applicant: MODI CONSULTING AND INVESTMENTS PTY LTD., Victoria (AU)

(72) Inventor: Jayesh Modi, (US)

(21) Appl. No.: 14/892,231

(22) PCT Filed: Jun. 20, 2014
(86) PCT No.: PCT/IB2014/062491

§ 371 Date: Nov. 19, 2015

(30) Foreign Application Priority Data
Jun. 21, 2013 (AU) 2013902261

(51) Int. Cl. B29C 45/00; B29C 49/64; B29C 45/72

(52) U.S. Cl. CPC B29C 45/0003; B29C 45/7207; B29C 49/64; B29K 2019/00

(57) ABSTRACT

A method for manufacture of an overmoulded article made up of at least two parts, so arranged that moulding first part according to parameters that are adapted for fastest possible cycle time without having any regard to temperature required at interface of second part moulding, cooling first part rapidly followed by heating face of the first part by application of heat before the said first part has completely cooled to room temperature, so characterized that at end of heating there exists at least three temperature zones in the first part namely zone 1, zone 2 and zone 3, the zone 1 closest to surface of the first part that was heated, the zone 3 near middle of thickness of the said first part and the zone 2 is inter spaced between the zone 1 and the zone 3, temperature in zone 1 is higher than temperature in the zone 2 and temperature in the zone 3 is higher than temperature in the said zone 2, followed by overmoulding a second layer on the so heated face thereby improving adhesion of second part and minimizing interstitial stress while achieving substantial reduction in overall cycle time.

This application claims priority from an Australian provisional application number, 2013902261, Filed 21 Jun. 2013 which is incorporated by reference in its entirety, including any drawings, and for all purposes, herein.

### FIELD OF THE INVENTION

This invention is directed at an improved method of overmoulding aimed at reducing cycle times, improve interstitial bonding and reduce interstitial stress in sequential multi shot injection moulding of same or different material combinations, hard-soft overmoulding, application of coatings through injection process, applicable to thin to very thick parts, by way of example moulding of TIR Lens for LED automotive headlamp.

### BACKGROUND TO THE INVENTION

Injection moulding Hard/soft overmoulding has become a fundamental technique for injection molders in recent years. Soft grip hand tools, kitchen utensils, food storage containers having profile soft seal moulded on its edge are few examples. Yet another important application of multi shot injection moulding is in the manufacture of very thick articles and manufacturing the same by overmoulding method, thereby reducing maximum thickness of a single step that helps reduce total cycle time needed to mould the article, a most notable example being optical TIR lens of an automotive headlamp using high power LED as light source. Maximum thickness of such a lens can be in the vicinity of 31 mm. and typical cycle time in single shot moulding can exceed 20 minutes. That makes economic mass production difficult. In such a case common approach to reduce cycle time and thus by cost of production is to split thickness in multiple layers and mould them sequentially, each layer in this case may be made of same resin and second layer gets moulded on top of first layer, either on one side or both sides. If more than two moulding steps are employed same process is repeated for each additional moulding step. This method of reducing the maximum thickness moulded at any time has an additional benefit in that thickness related in-mould and post mould shrinkage is reduced that leads to improved part accuracy, minimizing or in some cases eliminating complex and very expensive step of remachining tool face with compensation for shrinkage. For sake of simplicity following discussion will consider two shot moulding—the first shot overmoulded with the second shot only one side only, however same discussion can be extended to moulding second layer on both sides of first shot simultaneously, a number of additional layers sequentially moulded on the same or opposite sides or moulding second shot all around encapsulating first shot.

Overmoulding process requires either two injection molding machines or a main machine and may involve another auxiliary injection unit on the same machine, an expensive and complex tool, may involve multiple material injection gates and may involve indexing arrangement. The first material is injected moulding first part also called first shot, and then the mold is indexed or transported to the second injection machine/unit where the second material is injected onto the first part, commonly known as 2K or sequential two shot moulding. The first shot is cooled until it reaches sufficient rigidity that the tool can be opened and the first part is able to be handled and presented to second set of tool cavity wherein the second layer will be injected either on one side of first shot, simultaneously on both sides or all around encapsulating the first shot. The step of presenting the insert to the second stage of injection moulding is carried out, for example, by means of a rotary platen or an indexing platen, a sliding table, retracting cores or a robot. Also conceivable is the use of two or more independent injection molding machines and tools. Here, each machine can be responsible for moulding at least a layer of molded parts and transfer between the machines is made by appropriate means.

Yet another significant application area of overmoulding is in medical devices: liquid silicone rubber overmoulding and typical candidate parts, gaskets, seals, fluids, catheters and implants, again, they require the insert part to be hot to achieve good bond strength.

In multi shot moulding, key factors to a successful overmoulding operation are that there is a strong bond achieved between the first shot and subsequent shot, the interstitial stress is kept to a minimum and in many applications the bond has to be leak tight, for example diaphragm seals having an integral mechanical connection. This bond may be derived entirely from melt and/or chemical adhesion between the surfaces of the two components that may be supplemented by mechanical interlocking features. However, it is possible that this may leave a minuscule gap on the interface due to incomplete melt soft bond and, for example on a kitchen utensil grip, such small gap can provide a breeding ground for bacteria and can become a source of health hazard.

Another process of interest is the integration of injection molding and application of coatings e.g. hard coats on polycarbonate that can completely replace conventional painting, including pre- and post-paint work processes. This involves the production of multilayer parts with premium high-gloss surfaces in a fully automated process, e.g. a demonstration project of a student bag (Hofmann Innovation Group AG, Lichtenfels, Germany) made of ABS which has surface decorated with a solvent-free high-gloss polyurea protective lacquer as well as has a portion with TPU. In the first step the base material is injection molded. After the center plate of the mold is rotated, the cavity closes again and the second, soft component thermoplastic urethane (TPU) is injected to form the handle as well as the connection part on the bottom. Now, the specially developed lacquer component is overmoulded in a very thin layer. It should be noted here that overmoulding TPU and injecting of lacquer requires correct temperature in tool and also on the first part and that can be quite different than that required for cost effective moulding of the first part and in turn might force moulding the first part at high tool temperatures and affect it's cycle time reducing process throughput and increasing cost.

In the case of melt adhesion the two components mutually solvate at the interface and form a bond. Since the hot substrate, if at sufficiently high temperature, will usually be in a semi-solid, gel phase at this point, melt and chemical bonding is generally better than can be achieved by insert molding over an unheated substrate. The strength of this bond is affected by several factors, including interface temperature, cleanliness of the insert and melt temperature of the second shot resin. Hence it is very common practice to mould 2K components at very high tool temperatures that may be combined with high melt temperatures, consequently that leads to very long cycle times. The polymer is possibly degraded and the cost of the product increases. Alternate method industry applies is to mould the first part using optimal process parameters, transfer it to a storage where it generally cools to room temperature, part is retrieved from storage at a later time and heated in a heating chamber and overmoulded with, for example thermo plastic elastomers (TPE). It should be noted that it consumes more energy as component is first cooled while in storage and heat may have to be applied again and will be applied to entire part rather than being localized to the edge or surface where the extra temperature may be required to improve bond. This heating step also affects the overall size of component due to thermal expansion, which may experience substantial dimensional growth and thus affect its fit within the second shot moulding tool affecting uniformity of second shot dimensions and quality of the end product.

Many applications, by way of example, prefer the strength of nylons in the substrate, however nylons can easily absorb moisture from the atmosphere when in storage and that surface moisture can impede strong bond when overmoulded with, for example thermoplastic elastomers (TPE).

It is also a big problem in the industry that many material combinations are currently not possible or industry finds it hard to realise, by way of example overmoulding PC+ABS with TPE (Santoprene from EXXONMOBIL), as industry experience suggests thermoplastic elastomers (TPE) will bond reliably only with PP.

Yet another limitation of the current state of sequential overmoulding technology is that a molder is restricted from using process parameters to fine tune dimensions of the first shot part, for example by reducing the mold temperature or reducing melt temperature to reduce shrinkage as it could potentially impact bond strength.

There are numerous attempts being made to improve profitability of business by reducing cycle time to mould an article of acceptable quality.
1. Multi-Layer-Spritzgieβen von LED-Collimator Linsen 2013-03-25 by Michael Roppel, Bayer Material science—provides excellent introduction to use of multi-layer moulding of automotive LED headlamp TIR lens.
2. WO2011045314A1, Bayer, discloses a method for simulating multi-layer moulding and means to optimize split thicknesses so as to achieve balance in cycle time between first and the second shot, primarily using HyperWorks® engineering tool.
3. WO2012069590A1, Bayer, Klinkenberg multi shot moulded Lens having a colder inner layer tool allowing deliberately inferior surface quality from the first shot and then completely covering it with the second shot, the option shown as triple layer where second shot is applied to both functionally important faces of the first shot (FIG. 1A). Reports up to 45% reduction in cycle time.
4. WO2011091529A1, Reflex, discloses ribbed insert moulding method (FIG. 1B), this method claims to reduce cooling time and overcome voids. However, potentially will have surface irregularities associated varying thickness in the final layer.
5. DE 102008 034153 A1, Engel Austria, Giessauf Josef, discloses a means of moulding multi layer lens (FIG. 1C).
6. EP 2402 140 A1, Automotive Lighting Reutlingen, Method for manufacture of a plastic lens of a motor vehicle lighting device, plastic lens produced according to the method and tool for the manufacture of the plastic lens discloses a means of moulding a multi layer lens, focused more on tool construction (FIG. 1D).
7. EP 2578376 A1, Valeo, Optical part having a core and a plurality of layers.
8. “Development Of Alternative Process Technology For Multi-Component Injection Molding”, (Dr. Ing. Rainer Kleeschulte, Universität Paderborn, Hohenloher Weg 16a, 33102 Paderborn.EP 1785255 A1, Wilhelm Weber GmbH & Co. KG,
9. Process and injection moulding apparatus for manufacturing a light guide. WO 2013144025 A1, Sumitomo (Shi) Demag Plastics Machinery GmbH, Injection-moulding machine for manufacture of multilayer plastic article.
10. DE 3809969 A1, Ishida Kohki Seisakusho Co, Process for the manufacture of a lens. Joining of preformed parts of lenses by hardenable resin.

A moulded article, particularly an optical component moulded out of polycarbonate or

PMMA may be made of single layer, for example, automotive headlamp cover, multiple layers, e.g. thick lens made by multi-shot method of same material or multiple parts joined end to end, by way of example only, an automotive tail lamp cover for the turn indicator having clear, orange and red colour sections made of, for example Makrolon PC LED 2245 supplied by Bayer AG.

In most common form injection moulding process involves injecting molten resin in a tool cavity and cooling it till the part reaches its demoulding temperature followed by ejecting the so moulded part. As is well known in the industry and academia, the temperature profile through the thickness of a part on ejection will be an inverted parabola (FIG. 2), generally in the vicinity of the geometric mid-plane of the material will have highest temperature and will have the coldest temperature at the surface. The turning point of the parabola will be at the highest temperature, as described above in the vicinity of the geometric mid-plane and lowest temperature will be at the surface of moulding, which is influenced directly by the tool temperature. For a given moulding operation, lower cycle time is possible only with lower melt temperature and lower tool temperature and ejecting the part at high temperature.

The basic thermodynamic equations of cooling time of molten resin define that cooling time is proportional to square of the thickness of the part being cooled and cooling time for thick parts increases exponentially being quadratic relationship. There are two major difficulties in the moulding of very thick parts, for example, having thicknesses in excess of 10 mm. The first difficulty is development of air gap on cooling of such moulded part. As the article cools it develops an air gap on account of volumetric shrinkage associated with cooling. Particularly when such moulded part is very thick, the air gap is also very large and the thermal insulation effect of such an air gap can be detrimental to cycle time. One method to overcome this air gap induced thermal resistance consists of steps of filling a mold with molten resin, and the thick wall portion of the part is then pressed by gas pressure from a position corresponding to the back side of the part which helps eliminate the air gap in contact with tool on opposite side. This process improves heat removal efficiency and helps reduce cycle time. However, the direct application of the gas pressure causes the formation of irregular sink marks on the surface of the part resulting in an unsatisfactory surface appearance. Such systems are deployed very successfully in industry, for example External Gas Cool Flow systems as supplied by the Stieler Kunststoff Service GmbH, (http://cms.stieler.de/). These systems are deployed primarily to improve part appearance and the elimination of sink marks on appearance side, normally cavity side in the reproduction of “A” class surface in relatively thin parts having 3-5 mm. thickness.

Second difficulty with moulding very thick parts is internal voids that are formed on cooling, and they do create structural weakness and in the case of optical lens application they will render the lens useless. These voids are created by the fact that on cooling surface of an overmoulded article the surface improves its mechanical strength and stiffness and becomes rigid. On further cooling the so stiffened surface may not yield enough to compensate for reduction in volume associated with further cooling of the part and further cooling leaves internal voids. It should be noted that the colder the surface of part and/or higher the cooling rate higher the likelihood of internal voids. And therein lies limitation of the current state of art in the moulding of thick parts and particularly TIR lenses; typically these lenses are moulded at very high tool temperatures reducing the cooling rate and in turn have very long cycle times.

One most common approach among many of prior inventions and current state of overmoulding technology is to mold first shot at a relatively lower temperature as long as good bond with subsequent layer can be achieved and internal voids are avoided. Therein lie limits of how low the tool temperature can be practically deployed. In turn moulding cycle times are limited by minimum temperature necessary for bonding to second layer successfully and not by absolute minimum temperature the first shot can be moulded, thus it falls short of achieving shortest possible cycle time.

Another major limitation in current processes described above is that even if bond was possible at lower surface temperature of first shot moulding, it is not practiced since the second shot melt could experience frozen skin effect when it touches the very cold first shot surface and may not fill completely when second shot is a thin skin, introduce interstitial stress and in many high quality optical applications the stress may affect optical performance of TIR lens and introduce errors like Birefringence. This is exacerbated by the fact that the tool surface for second shot may be preheated to a relatively high temperature to achieve improved reproduction of surface, which may contain Nano structures, e.g. beam shaping property through Nano pyramids. Very high temperature differential between two opposing walls in contact with melt can lead to more distorted filling and freezing pattern—one face very cold and another face very hot, that can lead to bubbles by air entrapment, uneven cooling rate and affect quality of moulding. These parts additionally may require application of a coating known as hard coat, which is necessary to improve resistance to chipping, scratching and chemical attack during outdoor application. This can become an additional expensive step in the process of manufacture of the finished article which may also affect profile precision as a coating only 2 microns thick is in reality 10 times higher than nano features which are typically of 200 nanometer in height and drown the nano features under the coating making them in-effective. This expensive post moulding coating line also suffers from a big disadvantage that the parts may have to be transported and may have to be buffered in an interim storage facility and the parts may get contaminated during transport or storage affecting final part quality and cost through rejects.

Currently major applications of TIR lenses having very high thickness are in the LED automotive headlamps, LED high bay lighting and LED street lighting. Currently they suffer from a major issue of yellowing of lens under attack by sunlight, UV factor from LED light source and associated very high ambient teperatures. This yellowing is one major contributor to reduced light performance over time. This is also affecting global adptation of LED technology for street lighting as municipal corporations demand stringent guarantees regarding light performance over service life exceeding 10 to 15 years.

It will be an advantage that at least some of the limitations described above are overcome and in particular means to enable fast moulding of overmoulded article having excellent surface reproduction, improved surface accuracy and yet have short cycle time.

### SUMMARY OF THE INVENTION

A method for manufacture of an overmoulded article made up of at least two parts in preferred aspect having permanent bond, they may be moulded of same or different materials, in one form consists of moulding the first part also known as first shot followed by overmoulding at least another part, second part also known as second shot and is having in common at least some surface of the first part. Injecting a first material into the first cavity to mould the first part is followed by at least partially cooling the said first part. Now the part is moved to second cavity or part of tool opened exposing at least the surface that is to be overmoulded. The inventive step described here is, before the first part has completely cooled to room temperature first part surface temperature is raised, to a suitable temperature that is necessary for good bond, by application of heat to surface of the first part which is to have permanent bond with second part so characterized that at end of heating there exists at least three temperature zones in the first part namely zone 1, zone 2 and zone 3, the zone 1 closest to surface of the first part that was heated, the zone 3 near middle of thickness of the said first part and the zone 2 is interspaced between the zone 1 and the zone 3, temperature in zone 1 is higher than temperature in the zone 2 and temperature in the zone 3 is higher than temperature in the said zone 2. Advantageously this helps overcome condensation on cold surface of first part whilst helping to improve bond with second part and reduce interstitial stress during overmoulding. Use of heated first part surface and heated tool surface keeps melt from freezing for longer allowing uniform isostatic compression during packing phase of injection moulding, if second part is being moulded on both faces of a first part shift/ offset of first part is minimised, most notable example being optical TIR lens of an automotive head lamp using high power LED as light source.

The overmoulded article as above is produced in a two stage tool that forms part of a manufacturing cell having an intermediate station. The moulding tool may be configured as a shuttle or a rotary tool containing at least two moulding stations and includes means of transporting moulded articles from first stage tool to the intermediate station and from intermediate station to second stage tool and out of the cell. The means of transport may be made up of by way of example only pick and place robots, conveyors, indexing tables or combination. Once the first part is produced by injection moulding, it is transferred to the intermediate station wherein exists arrangement for cooling the first part and arrangement for heating the first part and it may have optionally buffering capacity which broadly speaking forms part of the same manufacturing cell. For example this intermediate station could be a conveyorised chamber having been fitted with two stations, one arrangement for cooling and one arrangement for heating. The cooling of the first part is followed by application of heat to the first part as it traverses through the chamber having arrangement for heating, having sufficient conveyor length and speed of conveyor so adjusted that it has same throughput rate as throughput rate of the moulding machine and the heated article exits at predetermined surface temperature. Main advantage of such cooling outside of first cavity is that the first part can be ejected out of the tool lot faster and at high temperature and further cooling is carried out outside the moulding tool thus by improving productivity of moulding machine and net output. It is quite practical to eject the part out of first cavity once sufficient frozen skin is formed and inside is still molten as long as the part can be handled safely. Here the article may be cooled, by way of example only, by passing through intermediate station as described above wherein exists arrangement for cooling. Advantageously before the first part has completely cooled to room temperature first part surface temperature is raised to a suitable temperature that is necessary for good bond, by application of heat to surface of the first part which is to have permanent bond with second part so characterized that at end of heating there exists at least three temperature zones in the first part: zone 1, zone 2 and zone 3, zone 1 closest to surface of the first part that was heated, the zone 3 near middle of thickness of the said first part and the zone 2 is interspaced between the zone 1 and the zone 3, temperature in zone 1 is higher than temperature in the zone 2 and temperature in the zone 3 is higher than temperature in the said zone 2. Advantageously this helps overcome condensation on cold surface of first part as it exits the intermediate chamber whilst helping to improve bond with second part and reduce interstitial stress during overmoulding. Such heated article is transferred from the said heating station to second cavity and is followed by injection moulding of the second part thereby manufacturing the moulded article.

In yet another embodiment of the invention the overmoulded article as above is produced in a two stage tool wherein the first part is produced by injection moulding and without intermediate holding or heating station the first part so moulded is transferred to second stage moulding tool. Advantageously before the first part has completely cooled to room temperature first part surface temperature is raised to a suitable temperature that is necessary for good bond, by application of heat to surface of the first part which is to have permanent bond with second part so characterized that at end of heating there exists at least three temperature zones in the first part: zone 1, zone 2 and zone 3, zone 1 closest to surface of the first part that was heated, the zone 3 near middle of thickness of the said first part and the zone 2 is interspaced between the zone 1 and the zone 3, temperature in zone 1 is higher than temperature in the zone 2 and temperature in the zone 3 is higher than temperature in the said zone 2. Advantageously this helps overcome condensation on cold surface of first part whilst helping to improve bond with second part and reduce interstitial stress during overmoulding. It is followed by injection moulding of the second article thereby manufacturing the moulded article. Here the innovative step is that the traditional step of heating the insert offline and transferring it to moulding stage is eliminated and heating of the overmoulded article is achieved inside the mould. Thus the additional equipment and factory floor space requirement is at least partly eliminated. Another issue with heating the insert outside the tool is that it affects its size due to thermal expansion when whole article is heated as is case in traditional method which in turn can affect its overall dimensions and its fit in the second stage moulding tool requiring additional modifications and resizing of pockets to receive inserts. This also takes up lot more energy and time compared to heating a small part of the insert, or only select surface of insert.

The overmoulded article previously referred to is produced in a two stage tool wherein the injection moulding tool setup is having at least two mould cavities, the first cavity and the second cavity. These cavities are so arranged that the first cavity and the second cavity are in flow communication having at least some common surface enabling the first part and the second part to be joined at the said common surface to form the moulded article. The first cavity and the second cavity are initially having blocked flow communication between the first cavity and the second cavity. Firstly the first part is produced by injection moulding, opening flow communication between said first cavity and second cavity, by way of example only including but not limited to, retracting a wall of first cavity that may also form a wall of second cavity, at least on one side of said first part by way of movement of at least some part of tool inserts, for example retracting cores driven by hydraulic or servo electric motor. This is followed by before the first part has completely cooled to room temperature first part surface temperature is to a suitable temperature that is necessary for good bond, by application of heat to surface of the first part which is to have permanent bond with second part so characterized that at end of heating there exists at least three temperature zones in the first part: zone 1, zone 2 and zone 3, zone 1 closest to surface of the first part that was heated, the zone 3 near middle of thickness of the said first part and the zone 2 is interspaced between the zone 1 and the zone 3, temperature in zone 1 is higher than temperature in the zone 2 and temperature in the zone 3 is higher than temperature in the said zone 2. Advantageously this helps overcome condensation on cold surface of first part whilst helping to improve bond with second part and reduce interstitial stress during overmoulding. It is followed by injection moulding of the second article thereby manufacturing the moulded article. This allows for less expensive tool however is restricted to part geometry where such movements are possible and resulting parting line is acceptable.

Method for manufacture of the overmoulded article according any of preceding discussion wherein advantageously wall temperature of the first cavity and the second cavity is rapidly raised prior to injection of melt and rapidly lowered post injection as is case with RHCM or Heat Cool moulding technique. Process parameters for moulding of the first part and the second part are adapted for fastest possible cycle time without having any regard to temperature required at interface of the first part and the second part, including but not limited to melt temperature, packing pressure, tool surface temperature and cooling time. As we can deliberately tolerate inferior surface quality at this stage and quality of bond will be improved by application of heat as described above.

Cooling of the first part as described above involves traditional method of passing cooling medium through cooling channels built in the tool.

As thick article solidifies in tool the associated shrinkage creates air gap between the article and the adjacent tool surface and this air gap inhibits further cooling of the article. Cycle time is advantageously reduced by providing cooling of the first part after injection of polymer in tool cavity by passage of cooling medium through cooling channels built in the tool followed by passage of cooling gas directly in contact with at least a part of the said first part. This cooling typically involves very cold inert gas having temperature of the order of −52 Deg. C having very high purity passing, directly through the air gap as referred to above, over the surface of moulded first part.

It is a common problem in optics industry that high thickness moulding can be anisotropic and inhomogeneous having non-uniform density that leads to birefringence in optical moulding. Exit of cooling gas as described above is through a pressure regulating valve such that predefined back pressure is maintained by the gas in contact with first part. Advantageously such cooling gas is applied with substantial pressure thus by pushing further shrinkage inwards from surface rather than freezing the surface forming skin and further shrinkage leaving voids internal due to reduction in volume on cooling. Advantageously density variation is effectively reduced by isostatic pressing of moulding during cooling stage by passing cooling gas under high pressure.

Method of cooling by way of intermediate station as discussed earlier wherein the first part is cooled after ejection from first cavity as it traverses through arrangement for cooling first part that in preferred embodiment is a climate controlled refrigerated chamber having humidity control to avoid condensation wherein the first part cools by radiation to cold chamber walls as well as by convection by circulating purified cooled gas or air directed at its surface or combination of both modes.

In yet another embodiment of the invention cooling of first part is carried out by conduction in contact with plates, preferably on both sides of first part, that are independently movable and are having matching shape as that of first part, maintained at very low temperatures for example −52 Deg. C for example by application of CO2 cooling. The plates are so configured that they maintain constant pressure on the first part as it cools and shrinks so that all the shrinkage is pushed towards inside of material and formation of voids is avoided. This advantageously by isostatic pressing of first part during cooling helps overcomes density variation as well as risk of voids developing on rapid cooling of thick cross section first part.

In yet another embodiment of the invention cooling of first part is carried out by conduction in contact with plates or multiple independently movable smaller plates or plungers, preferably on both sides of first part, having matching shape as that of first part, maintained at very low temperatures for example −52 Deg. C. These plungers or plates are so configured that they maintain constant pressure on the first part as it cools and shrinks so that all the shrinkage is pushed towards inside of material and formation of voids is avoided. This advantageously helps overcome density variation as well as risk of voids developing on rapid cooling of thick cross section first part by isostatic pressing of first part during cooling. These plungers or plates are provided with at least one protruding member typically less than 5 mm. in maximum height that may be integral to the said plunger and said protrusion is generally conical or hemispherical in shape like a half dome having generous rounded edges and fillets and is free of sharp corners. When pressed in contact with first part surface the protrusion breaks through frozen skin and helps with more uniform pressing of the first part. Overmoulding of second part covers up the dimple mark left in surface of first part by such cooling plates. These plunger and the said protrusion are maintained at very low temperatures including but not limited to −52 Deg. C for example by application of CO2 cooling.

Partial vacuum during injection fill stage of moulding helps with venting the cavity and reduce the risk of particulate, volatiles or dust entrapment and also reduce chance of dieseling that causes burn mark on the moulding if the gases cannot be vented quick enough, particularly if the shot size is large. Accordingly negative pressure or partial vacuum is maintained in the first cavity and or second cavity prior to injection of liquefied polymer for moulding of first part and or second part. Furthermore damage to part surface on account of dieseling is avoided by purging air inside cavity with N2 before drawing partial vacuum: being inert does not burn polymer even though pressure is increased during moulding cycle.

It is typical that melt travels from machine nozzle via various sub components of a modern moulding tool comprising but not limited to shutoff nozzle, hot runner manifold, shutoff valve, cold runner, cold sprue and gate where melt enters the mould cavity. Method of maintaining partial vacuum wherein at least one connection to a vacuum source from the second cavity is configured such that at least one connection to vacuum source at the second cavity is substantially same as at least one entry point of liquefied polymer melt entering the second cavity. For example this could be a hot runner nozzle or valve gate configured with vacuum connection. At least some extracted air or gas from the first or second cavity traverses through a passage that at least partially is in common with passage used by liquefied polymer melt entering the second cavity. Junction point between further passage upstream to vacuum source and melt passage is provided with a blocking mechanism that allows flow of extracted air or gas to pass through to vacuum source and and melt is prevented from entering further passage upstream to vacuum source. This helps reduce connection to inside of cavity and makes it easy to retrofit the solution in existing tools.

Alternatively positive pressure is maintained in the first cavity and or second cavity prior to injection of liquefied polymer for moulding of first part and or second part. It is known to help with proper flow front development whilst controlling jetting during injection of polymer in large cavities.

In yet another embodiment of the invention the first part as discussed above is a label or an in mould decoration (IMD) it is transferred in first cavity by appropriate automation means. Here the traditional method has a problem that the insert could develop wrinkles or end up having excessive compressive stress as the moulded resin shrinks on cooling while the label or IMB insert does not shrink as much. Here advantageously the heating the insert offline and transferring it to moulding stage with purpose of achieving good bond without wrinkles is eliminated and heating the insert is achieved inside the mould by altering surface temperature of the first part by application of heat directed at selectively surface of first part which is to receive second part bonding at second stage overmoulding step and the overmoulding is carried out by injection moulding process, by way of example injection moulding decorative film deckle (IMD) or capacitive film in a touch switch panel application. The moulding as above for a label or IMD insert is by blow moulding process by way of example milk bottle.

Second part according to any of preceding discussion includes application of any one of, by way of example but not limited to, coating by injection moulding, lacquer by injection moulding, liquid silicone rubber (LSR) by injection moulding, application of thermo plastic urethane (TPU) coat by injection moulding.

Second part according to any of preceding discussion includes application of combination of, including but not limited to, coatings by injection moulding, lacquer by injection moulding, liquid silicone rubber (LSR) by injection moulding, application of thermo plastic urethane (TPU) coat by injection moulding applied simultaneously or separately in a sequenced injection moulding manner. Method of application of heat can be by a heater panel that slides in the open tool preheating first shot as well as optionally the mould surface. The heater panel may be configured with, by way of example but not limited to, IR heat source or heated gas nozzles. As many high quality surfaces require heating the tool in RHCM/Heat-Cool mode, additional heat applied simultaneously to mould surface can help reducing RHCM dwell time for heating the mould surface.

Application of heat, as referred to previously is preferably applied by heated inert gas. Typically heated Nitrogen or Carbon Dioxide are suitable gases; heating the insert by heated inert gas which has advantage that risk of oxidation of first shot overmoulded article is minimised.

Alternatively application of heat can be by heated air, helps reduce cost associated with inert gas if risk of oxidation is not an issue or can be tolerated due to lower quality requirements, for example opaque moulding of a kitchen brush handle. Preferably the tool for the second article is provided with at least one elongated cylindrical chamber having external thermal insulation so as to minimise the energy loss. The chamber is at a location removed from the moulding surface and has easy access for maintenance. This chamber is fitted with a heater cartridge that is, preferably, but not limited to electrically heated fin type cartridge. In a preferable aspect the heater has a tube at its central axis that runs substantially full length of the said chamber and has a small gap at its inner most end. The un-heated gas enters the said tube at its outer end near to the outside of tool, travels through to far end of tube and travels over the heater element fins picking up heat as it travels back towards the said open end, now hot gas preferably travels through internal passage in communicable connection with the second cavity wherein it preheats the surface of first part as well as surface of second cavity. Advantageously heat is applied only to that portion of the first part that is to receive second part bond and overall heating of the first part is avoided.

Alternatively the heating arrangement for gas is a compact heater mounted external to the tool having connection to an unheated gas supply and having a communicable connection to the passage in communicable connection with second cavity wherein it preheats the surface of first part as well as surface of second cavity. Advantageously heat is applied only to that portion of the first part that is to receive second part bond and overall heating of the first part is avoided.

Preferably supply of heating medium of gaseous form is characterized by at least one entry point to the second cavity and at least one exit point from the said second cavity such that the entry point and exit points are substantially removed from each other and heating medium is forced to pass over the face of first part heating the face substantially uniformly and advantageously heat the tool face at the same time. Exit of heating medium above referred is characterized by maintaining a small gap on parting line of second cavity of the order of maximum 2 mm. such that it provides opportunity for heating gas to escape from said cavity after exchanging heat with the said first part and the tool face followed by completely closing the tool and moulding of second article. Thus the additional vent connections are eliminated reducing some aspect of tool complexity.

Advantageously maximum gap above is preferably 0.2 mm., thus reducing consumption of gas.

Even more advantageously maximum gap above is preferably 0.05 mm. thus allowing maximum time for the gas to exchange heat with the first part and yet reducing consumption of gas.

It is typical that melt travels from machine nozzle via various sub components of a modern moulding tool comprising but not limited to shutoff nozzle, hot runner manifold, shutoff valve, cold runner, cold sprue and gate where melt enters the mould cavity. Advantageously at least one passage through which gas traverses before entering the second cavity is configured to at least partially share passage used by liquefied polymer melt as described above, thus avoiding any witness of gas entry point on the moulded article. This helps reduce connection to inside of cavity and makes it easy to retrofit the solution in existing tools. This is very useful when the part is having aesthetic requirements on both sided like a TIR lens and any such connection in functional surface ecan not be tolerated. Gas connection to above referred melt passage is so arranged via a valve that during the stage of melt being injected the melt does not enter the gas passage and gas heating system whilst during gas injection phase the gas is free to enter the tool cavity and preferably is blocked from flowing upstream melt passage towards machine nozzle.

Alternatively application of heat is by infrared radiation heater or infrared heat lamps, for example of the type typically used by vacuum forming industry, paint drying, and adhesive curing panel heaters.

It is important property of polymer materials that they are selective as to the wavelength and corresponding depth to which they are opaque or transparent to infrared energy. For example PP will absorb everything beyond 0.02 mm. depth at 3.43 microns wavelength, practically opaque, and be transparent to 2.6 mm. at 8-14 micron wavelength. The wavelength produced by the heat source is dependent upon the source temperature. It is possible then to adjust the source temperature and thus the peak wavelength to match the best spectral absorption rate and or depth of heat penetration. This is also important to avoid blistering the surface of article being heated by ensuring the IR energy is not localized only to top layer. This property can be advantageously employed to heat the surface of first shot moulding quickly without damage and also use less energy.

Application of heat, when tool is already closed is also possible by raising temperature of tool through internal heating, for example by passing steam or high pressure heated water through heat exchange conduits behind the surface of mould which in turn heats the mould surface, alternatively induction heating the tool surface which in turn can emit energy by infrared radiation heating the surface of first part. This can advantageously help with RHCM/Heat-Cool moulding whilst raising first part surface temperature. Preferably the tool surface is heated to a temperature higher than glass transition temperature of the first material or the second material whichever is higher plus at least 10 Deg. C.

Alternatively tool surface is heated to a temperature higher than Heat Deflection Temperature at 1.8 MPA (HDT, 1.8 MPA) for the first material or the second material whichever iss higher plus 10 Deg. C.

As in all good systems it will be advantageous to interlock moulding cycle to achievement of requisite temperature on face of first shot moulding. This is done easily through temperature sensors built into closed loop system and interlocking with process controller.

Application of heat according to any of preceding discussion is controlled by set time. Application of heat, according to any of preceding description, is controlled by closed loop feedback of sensing temperature on surface of first part being heated and set time delay after the said temperature has been reached.

For moulding of very thick parts of the type TIR lens for LED headlight it should be noted here that it can lead to a great reduction in cycle time if the process parameters for first shot are adapted for fastest possible cycle time without having any regard to temperature required at interface of second part moulding including but not limited to melt temperature, packing pressure, tool surface temperature and cooling time otherwise necessary for high surface quality or good interstitial bond as we can tolerate lower quality during the first shot as it is being covered over by second shot. Here we are intersted in final part and first part and second part dimensions individually are of no consecuence. And that enables us to mould a thicker part, larger than half the thickness in first shot and lower thickness in second shot, thus the total cycle time can be reduced. Total thickness of final article is divided amongst at least two articles namely first part and the second part and the proportional distribution of the two articles is predetermined through numeric simulation such that for individual and unique processing conditions for the first part moulding and that for the second article moulding cycle time estimates are essentially equal thereby balanced process flow is achieved without waiting by any station and in turn best possible overall cycle time is achieved. It should be noted here that various configuration of dividing the part may include but not be limited by moulding of second part on one side of first part or moulding of second part on either side of first part simultaneously or first part moulded with second part on one side and a third part moulded on top of second part. If the distance between the cavity surface and the heat exchange conduits is reduced it helps to reduce time for cooling as well as heating the cavity surface. If they are equidistant than cooling can be more uniform and hot spots in tool are reduced. Advantageously heat exchange conduits are uniformly distributed and are equidistant to molding surface as is known as CONFORMAL Cooling, the type of inserts available from http://www.Ultracool3d.com and http://www.contura-mtc.de/ among other sources.

If we maintain identical tool temperature through same coolant temperature through all parts of tool and cool an overmoulded article having substantially varying wall thickness, as is case with LED lighting headlamp TIR lens, we will have the part having vastly varying part thickness average temperatures. This is caused by the fact that thin section will cool lot faster than the thick section. This varying part thickness average temperature can lead to internal stress when thick part shrinks on cooling, surrounding part which was already at lower temperature does not shrink as much and will not shrink uniformly with thick part which will cause a zone having very high tensile stress in between the two having locked in residual stress and may show up among other things as birefringence in optical parts, warpage and dimensional variation on further cooling of the part to room temperature. In some application this could lead to part being rejected or in some instances change in dimensions happen at a later date on relaxation of locked in residual stress, possibly in field service, making it unusable over time. To improve this situation it will be desirable to vary cooling rate corresponding to thickness so that thick and thin sections cool at same rate and on completion of cooling cycle reach same part thickness average temperature. To this end rate of cooling rates in different parts of tool is varied by means of varying average tool stabilisation temperature in zones according to need to cool corresponding thickness of overmoulded article immediately in its vicinity. In preferred embodiment optimal cooling configuration incorporates any one or combination of the following including but not limited to dividing the cooling conduits in zones, varying the distance between the cooling conduits and cavity face, varying the distance between the cooling conduits, varying temperature of coolant flowing through each zone, varying coolant flow rate through each zone and varying the coolant flowing through each zone.

Variable cooling rates as per prior discussion are determined through numeric thermodynamic calculation or simulation.

Preferably the software used for the numeric simulation for deciding on thickness distribution and varying cooling rates is specialized software, but not limited to, UltraCalc developed by UltraCool3D.com.Other software packages that may be used include Ansys Workbench, Flowtherm to name a few.

Preferably the moulded combined article is transferred to stress relieving chamber maintained at specific atmosphere having specific temperature and pressure. This may have beneficial effect in reducing locked in stress and in case of high precision lens application optical performance and long term reliability of part.

Preferably the stress relieving chamber as above is maintained at suitable temperature and at suitable pressure that is higher than atmospheric pressure. This as discussed previously can have beneficial effect with rate of crystallization.

Preferably the stress relieving chamber is maintained at suitable temperature and at pressure that is lower than atmospheric pressure and walls of chamber are thermally insulated. This can help with reducing rate of cooling through convection and or radiation and allow more uniform yet slow cooling of very thick parts and improve dimensional and profile repeatability.

Polymers can be damaged by exposure to high temperatures and its effect is accelerated in presence of Oxygen. Preferably the stress reliving chamber is maintained with inert gas atmosphere inside of it.

It is a potential risk that a hot air chamber may transport some dust and may cause static by airflow on surface of overmoulded article and in turn dust can be deposited on the article making it defective. Advantageously the stress relieving chamber uses means of infrared heating.

It is important property of polymer materials that they are selective as to the wavelength and penetrated depth to which absorb infrared energy. Preferably the means of infrared heating are characterized such that they emit infrared waves at predetermined wavelength specific to material of the said second article such that the material of the said second article is opaque at the said infrared wavelength thus energy absorption is in the top layer rather than passing through it and improved thermal efficiency is achieved.

Alternatively we can direct heat to the interface of the two mouldings where it is likely to have maximum stress, infrared heating accordingly is characterized such that they emit infrared waves at predetermined wavelength band specific to material of the said first part and the said second article such that at specific wavelength band of the said wavelength spectrum the material of the said first part is opaque while the material of second article is transparent. Thus the maximum energy is delivered into the interstitial space or close to it.

Overmoulded article wherein the first part accordingto to any of preceding discussion includes at least a layer made of a material having high refractive index, for example Polycarbonate (PC) and second part having superior weathering and environmental resistance for example Poly(methyl methacrylate) (PMMA) preferably moulded on both faces such that it makes up a lens of the type TIR as used in automotive head lamp. This has advantage that high refractivity index of PC is applied to its full advantage thus by producing a reduced thickness lens having improved environmental protection including but not limited to yellowing resistance and its functional life improved.

Overmoulded lens according to to previous discussion wherein the second part is made of material having superior weathering and environmental resistance, for example Poly(methyl methacrylate) (PMMA) and has advantageously UV resistance properties built in the material, thus by producing a reduced thickness lens having improved environmental protection including but not limited to yellowing resistance and its functional life improved.

Overmoulded lens accordingto to previous discussion wherein the second cavity is providing free form surface having nano features and the second part is made of material having superior weathering and environmental resistance, for example Poly(methyl methacrylate) (PMMA)and has advantageously UV resistance properties built in the material thus by producing a reduced thickness lens having nano features and improved environmental protection including but not limited to yellowing resistance and its functional life improved.

### BRIEF DESCRIPTION OF THE DRAWINGS

In order that the invention may be more fully understood there will now be described, by way of example only, preferred embodiments and other elements of the invention with reference to the accompanying drawings where:

FIG. 1 Prior art.

FIG. 2 Temperature profile of a part from a tool having bilaterally symmetrical thermal design, inverted parabola shaped temperature profile. Temperature profile of a part of 31 mm. thickness moulded by single shot method, having 2298 seconds cycle time.

FIG. 3 Temperature profile of a part of 31 mm. thickness moulded by sequential two shot method, having 633 seconds cycle time.

FIG. 4 Temperature profile of a part of 31 mm. thickness moulded by sequential two shot method having 633 seconds cycle time, detailed view of temperature and trend line through temperature.

FIG. 5 Temperature profile of a part of 31 mm. thickness moulded by sequential two shot method having 272 seconds cycle time, very low tool temperature first shot, high thermal shock.

FIG. 6 Temperature profile of a part of 31 mm. thickness moulded by sequential two shot method having 272 seconds cycle time, very low tool temperature first shot, preheating first shot part and drastically reduced thermal shock.

FIG. 7 Temperature profile of a part of 31 mm. thickness moulded by sequential two shot method having 272 seconds cycle time, very low tool temperature first shot, detailed view with trend line through temperature.

FIG. 8 (Prior art) we are shown various joint designs for overmoulding, various mechanical locking features in overmoulding, we are also shown a typical tool configuration with moulding of metal insert with the first shot and overmoulding. We are also shown various combinations of moulding a lens type component having first shot moulding and overmoulding one or more layers.

FIG. 9 we are shown cross section through mould for first part of lens type, single sided heater and double sided heater preheating one side of first part.

FIG. 10 we are shown heating gas flow through partially open second article cavity, preheating one side of the first part, closed cavity showing space for second article, and moulding of second article on top of first part.

FIG. 11 we are shown heating gas flow through partially open second article cavity, preheating one side of the first part, closed cavity showing space for second article, and moulding of second article on top of first part. In this instant we are shown compact electrical heater for heating the gas built within the mould.

FIG. 12 we are shown cross section through mould for an article of TIR lens type having varying thickness.

FIGS. 13 and 14 we are shown summary bar chart of cycle time, mould stabilisation, coolant temperature, temperature distribution through an article of TIR lens type analysed for 3 thickness levels.

### DESCRIPTION OF THE PREFERRED EMBODIMENT AND OTHER EXAMPLES OF THE INVENTION

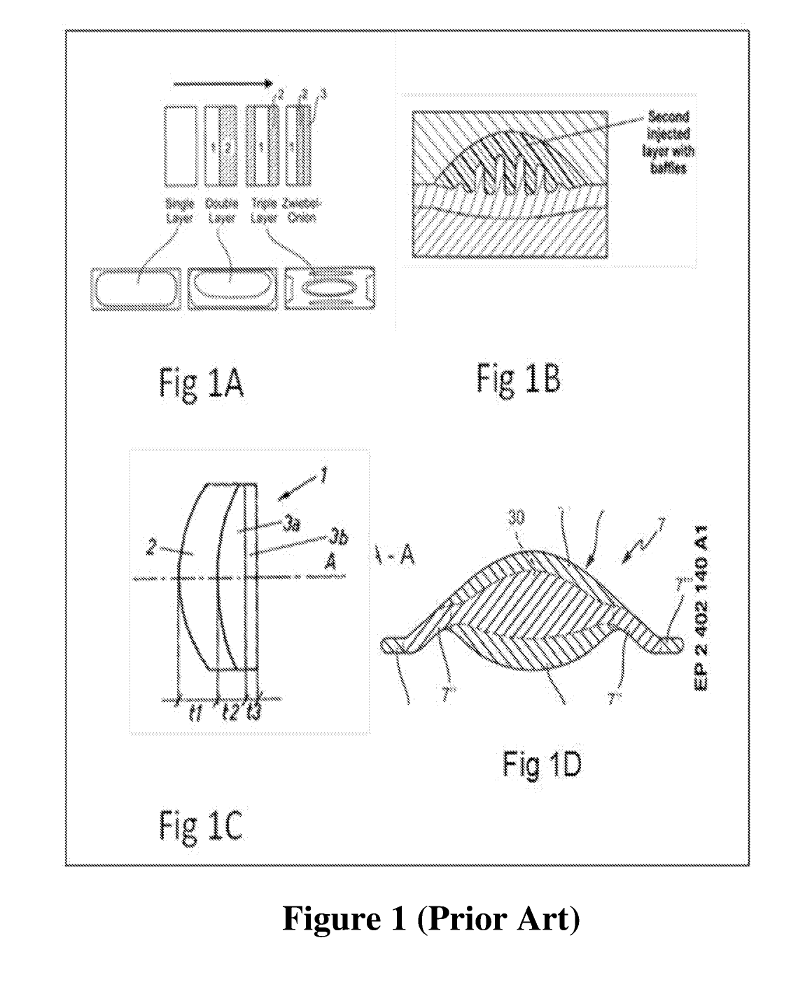

FIG. 1 (Prior art). FIG. 1 shows various forms of multi layer moulding to make up one larger thickness, single layer.

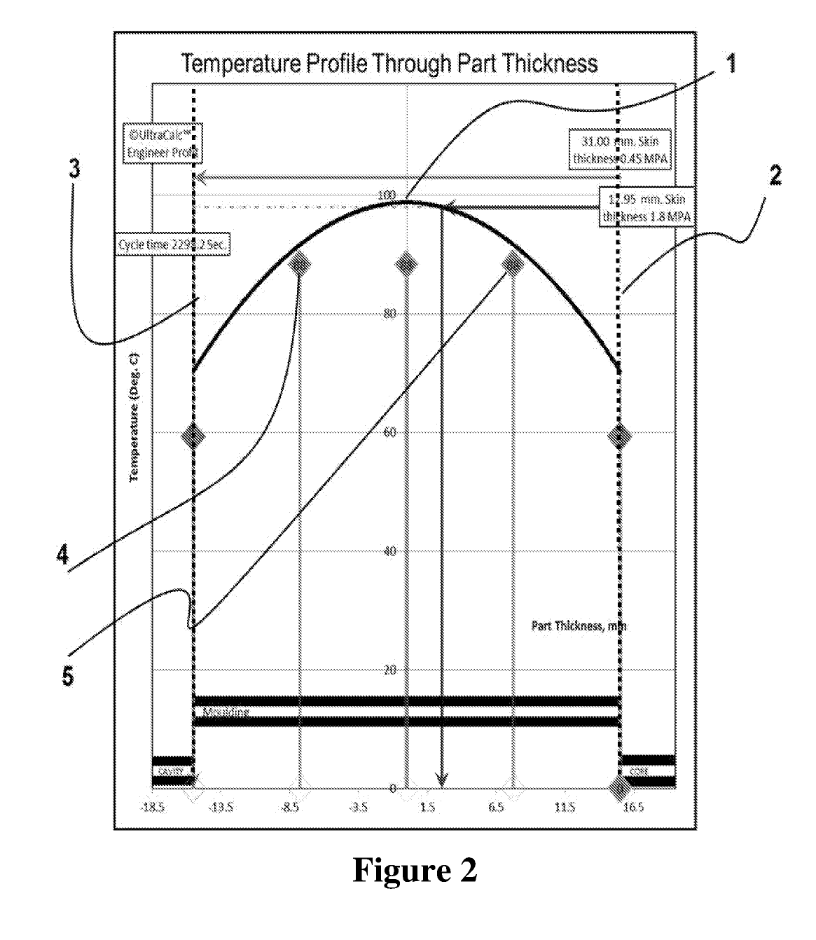

Referring to FIG. 2 we are shown temperature profile through a part bound between tool face at CORE (2) and tool face at CAVITY (3). As can be seen the temperature profile is symmetrical about plane having highest temperature (1) which also coincides with geometric mid-plane and average temperatures on core half of part (5) and average temperature of cavity half (4) are same. This is expected temperature profile of a tool having bilaterally symmetrical thermal heat transfer, typical when it is assumed that there is no thermal resistance on interface of polymer and tool face or if present it is equal on both sides of tool—CAVITY and CORE and cooling geometry made up of cooling channel size, distance to tool face and placement is identical on both sides of tool—CAVITY and CORE and temperature and flow rate of coolant are identical.

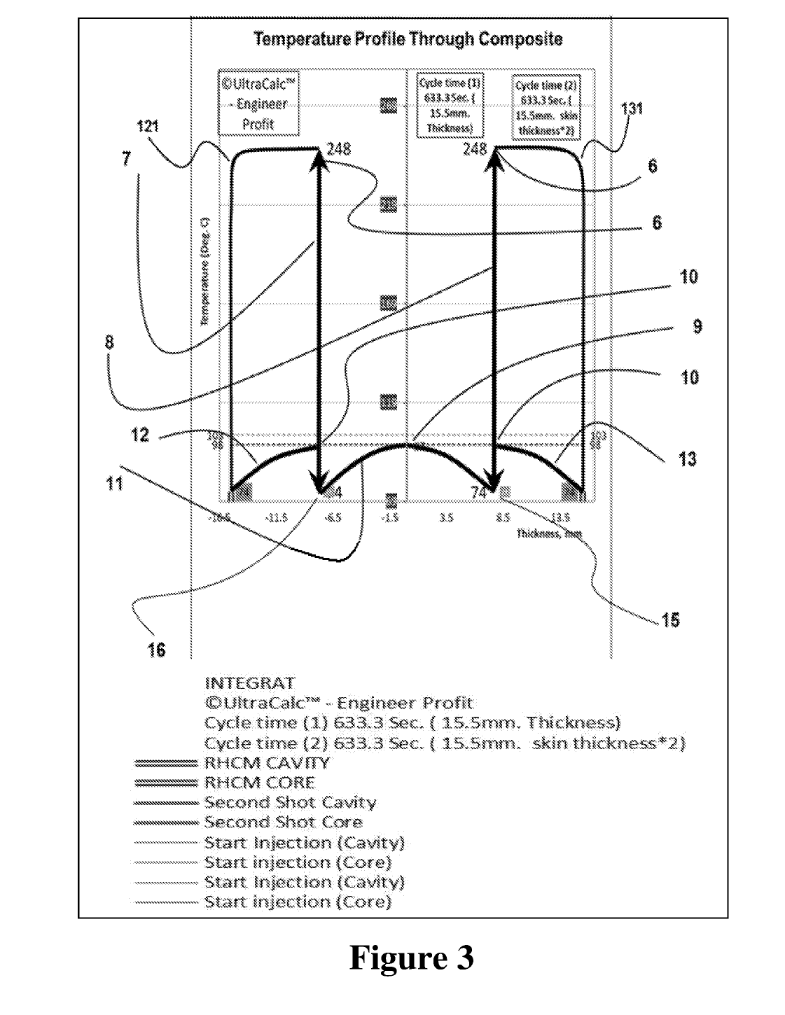

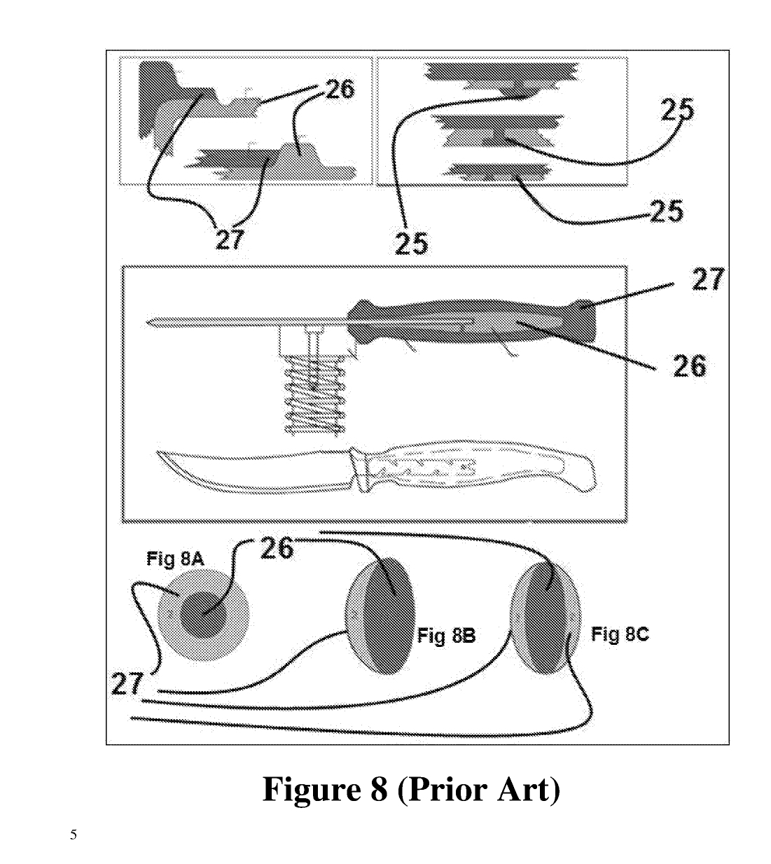

Turning to FIG. 3, for simplicity we are shown overmoulded part having bilaterally symmetrical overmoulding, of the type shown at FIG. 8C. We are shown a composite synthesized temperature profile through overmoulded part having temperature profile (11) of first shot part and temperature profile core side (13) and cavity side (12) of second shot part.

Temperature profile immediately after injection of melt is shown at 131 on core side and 121 at cavity side; temperature of resin at time of injection (6) has a temperature difference to surface temperature of first shot on core side (8) and cavity side (7). As can be noted the part centre temperature of first shot (9) and highest temperature of second shot which is at the interface with the first shot surface core side and at face of first shot at cavity side (10) are the same according to ejection criterion for both shots being same mid plane temperature. All things remaining same, it may be noted that in this instance first shot thickness is half of total final part thickness or the split is 50:50 between the first and second part.

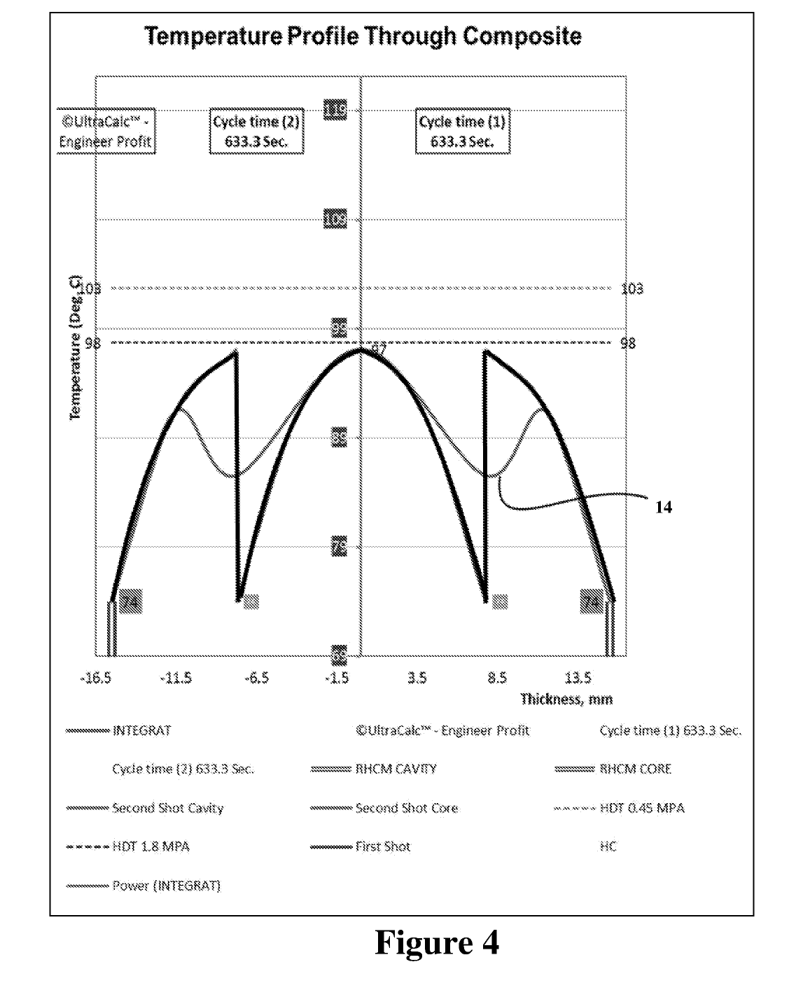

Turning to FIG. 4, for simplicity we are shown overmoulded part having bilaterally symmetrical overmoulding, of the type shown at FIG. 8C. We are shown enlarged view of a composite synthesized temperature profile through overmoulded part described at FIG. 3 above. We are also shown a geometric averaging curve (14) indicating smoothed temperature profile through composite moulding.

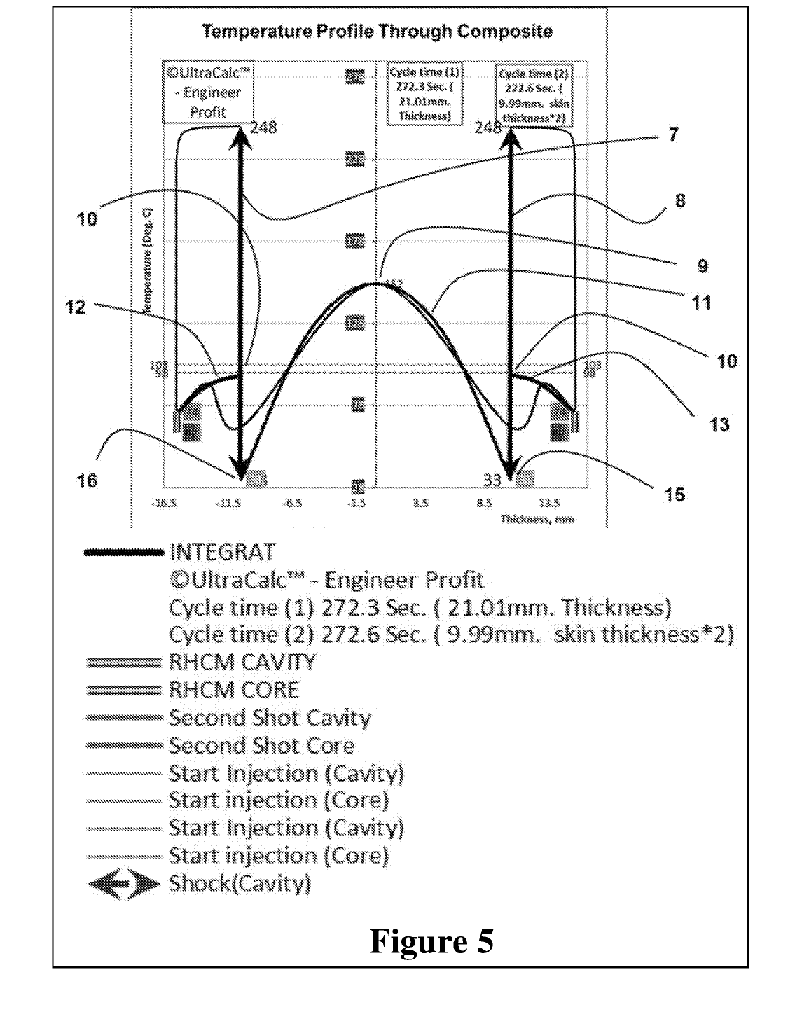

Turning to FIG. 5, for simplicity we are shown overmoulded part having bilaterally symmetrical overmoulding, of the type shown at FIG. 8C. We are shown a composite synthesized temperature profile through overmoulded part having temperature profile (11) of first shot part and that of second shot core side (13) and cavity side (12). As can be noted the part centre temperature of first shot (9) is higher than that of second shot on face of first shot core side and at face of first shot at cavity side (10). Also we can note that the temperature at surface of first shot on core side (15) and cavity side (16) are lower than previous case of FIG. 3. Temperature of resin at time of injection (6) has a temperature difference to surface temperature of first shot on core side (8) and cavity side (7) and is higher than the case shown in FIG. 3. This is a case of moulding the first shot at lower tool temperature and ejecting when it has cooled less than before allowing faster production. Here the first part has more thickness than combined thickness of second shot and total cycle time has reduced substantially.

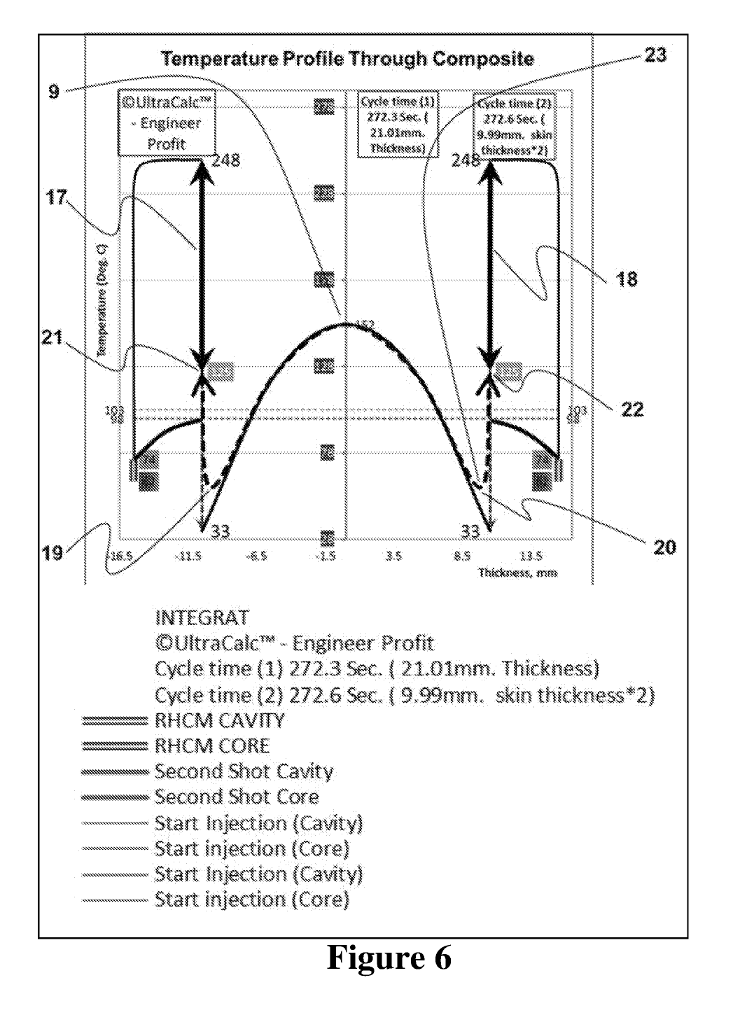

Turning to FIG. 6, for simplicity we are shown overmoulded part having bilaterally symmetrical overmoulding, of the type shown at FIG. 8C. We are shown a composite synthesized temperature profile through overmoulded part having temperature profile (23) of first shot part that has been preheated. After injection moulding of the first part, before the first part has completely cooled to room temperature heat is applied on the face of first part which is so characterized that at end of heating there exists at least three zones of temperature through thickness of the moulding such that zone-1 at surface of first shot having temperature (21,22) at end of heating that is higher than temperature (19,20) at a zone-2 which is inwards from surface and has also got yet another temperature zone-3 further inwards from said zone-2, that may be substantially in the middle, that is having higher temperature (9) than the said zone-2 temperature. By application of heat as described above temperature difference or thermal shock value between resin at time of injection of second shot and surface temperature of first shot on core side (18) and cavity side (17) is lower than the case without the heating on core side (8) and on cavity side (7), shown in FIG. 5.

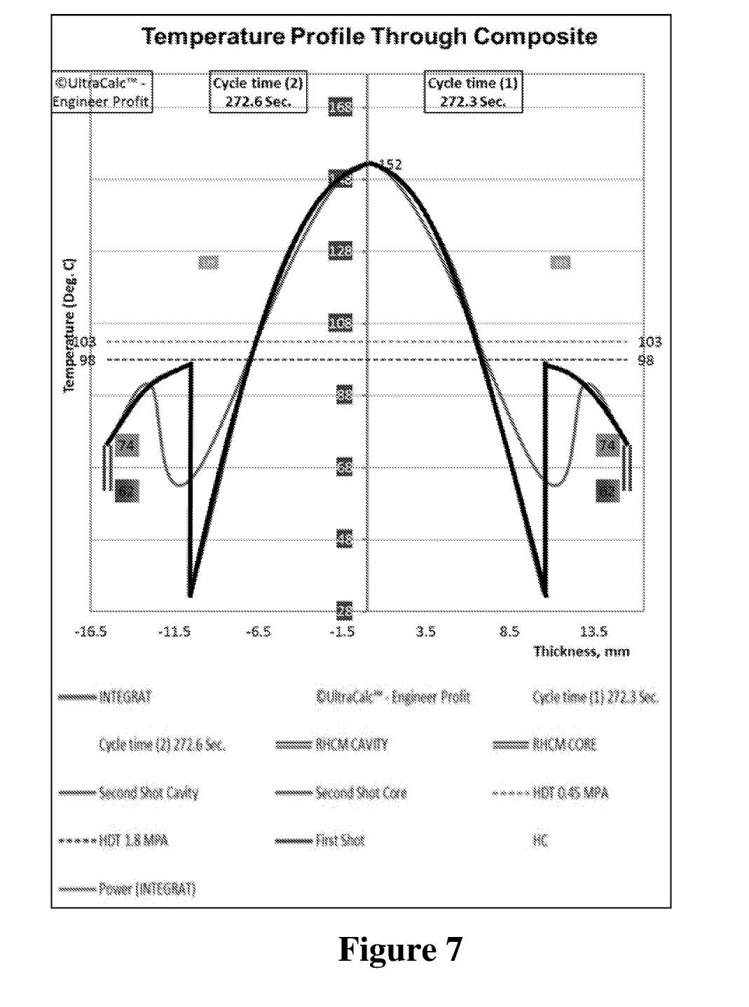

Turning to FIG. 7, for simplicity we are shown overmoulded part having bilaterally symmetrical overmoulding, of the type shown at FIG. 8C. We are shown enlarged view of a composite synthesized temperature profile through overmoulded part described at FIG. 6 above.

Turning to FIG. 8 (Prior art) we are shown various joint designs for overmoulding (24), various mechanical locking features in overmoulding (25). We are shown a typical tool configuration with moulding of metal insert with the first shot (26) and overmoulding another material (27). We are also shown various combinations of moulding a lens type component having first shot moulding (26) and overmoulding one or more layers (27).

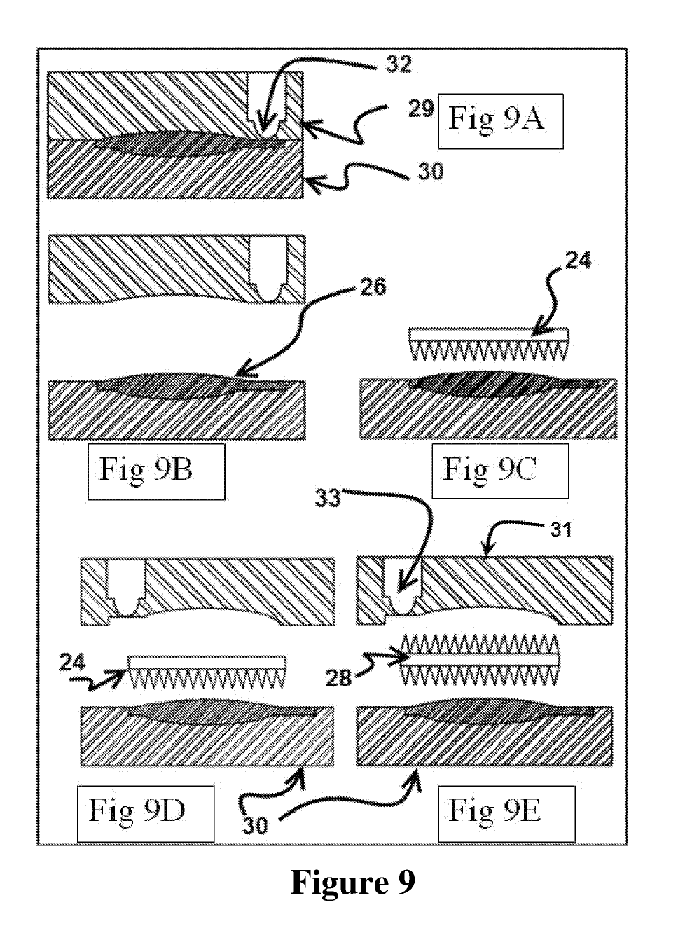

Turning to FIG. 9, for simplicity we are shown second part moulding only on one side of first part, of the type shown at FIG. 8B. We are shown at FIG. 9A—cross section through mould for the first part, comprising the first core (30), the first cavity (29), and first material injection gate (32). We are shown at FIG. 9-B core retracted away from cavity and the moulded first part (26) in contact with the core. At FIG. 9C we are shown the core in open intermediate position removed from cavity, single sided infrared heater (24) in position for heating of the first part. At FIG. 9D we are shown the core in position in front of the second cavity (31—shown at FIG. 9E), single sided infrared heater (24) in position for heating of the first part. At FIG. 9E we are shown the core in position in front of the second cavity (31), double sided infrared heater (28) in position for heating of the first part as well as the second cavity moulding surface. Source temperature of heating element is adjusted appropriate to maximising target materials absorption of incident radiation.

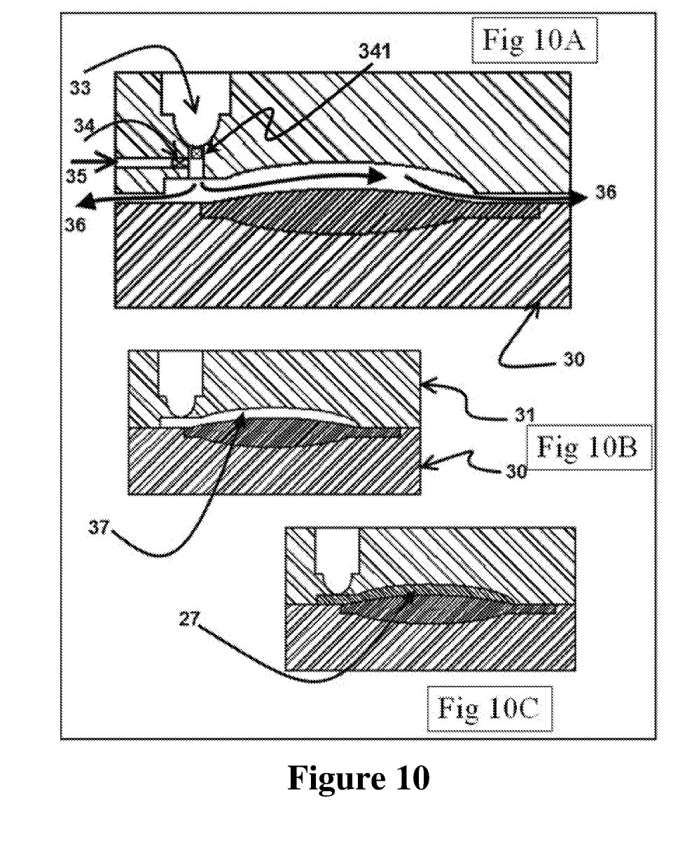

Turning to FIG. 10, for simplicity we are shown second part moulding only on one side of first part, of the type shown at FIG. 8B. we are shown at FIG. 10A—cross section through mould for the first part, comprising the core (30), the second cavity (31—shown at FIG. 10B), second material injection location (33). Here the core and cavity are not completely closed and shown with a small gap. The size of gap is so adjusted as to minimise the consumption of gas, help maintain required back pressure for a given flow rate of gas so that maximum heating is achieved for minimal cost and time or both as desired. We are also shown heating gas entry point (35), passing through blocking mechanism (34) that prevents entry of moulding material flowing into the gas passage backwards, we are also shown blocking mechanism (341) that prevents entry of gas towards machine through melt inlet passage. The gas shares the passage taken by moulding material flowing in from the injection point (33) and enters the space for moulding of the second article (37), shown at FIG. 10B and flows past the moulded first part and flows out of the said space into open (36). For simplicity there is no provision for recycling the spent gas shown here. FIG. 10B shows the second cavity (31) and the core (29) in closed position defining the space (37) for moulding the second part (27). FIG. 10C shows us the second part 27 moulded on top of the first part (26—shown at FIG. 9b).

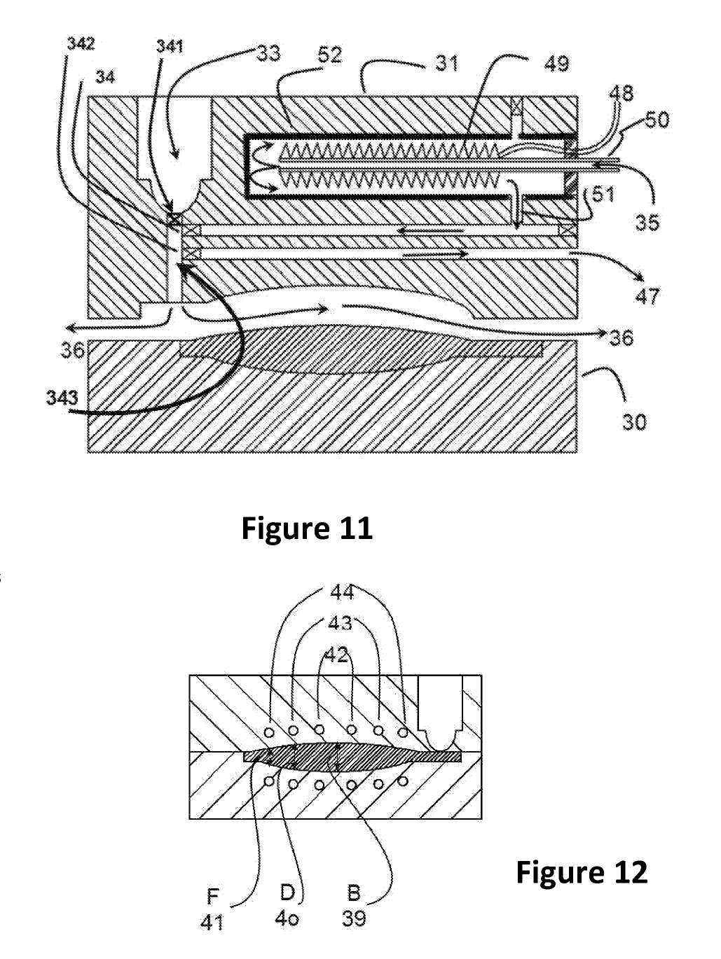

FIG. 11, for simplicity we are shown second part moulding only on one side of first part, of the type shown at FIG. 8B. We are shown an alternative embodiment of heating with gas, cross section through mould for the first part, comprising the core (30), the second cavity (31), and second material injection location (33). Here the core and cavity are shown with a small gap and are not completely closed. The size of gap is so adjusted as to minimise the consumption of gas, help maintain required back pressure for a given flow rate of gas so that maximum heating is achieved for minimal cost and time or both as desired. We are also shown heating gas entry point (35), passing through blocking mechanism (34) that prevents entry of moulding material flowing into the gas passage backwards. We are also shown vacuum connection (47), also connected to the liquefied material injection passage through a blocking mechanism (342) to prevent entry of liquefied material and blocking mechanism (341) that prevents entry of gas towards machine through melt inlet passage. The gas entry and vacuum connection share the passage taken by moulding material flowing in from the injection point (33) and are in communicably connected to the space for moulding of the second article (37, shown at FIG. 10B) and flows past the moulded first part and flows out of the said space into open (36). For simplicity provision for recycling the spent gas is not shown here. Disclosed here is a compact electrical heater (49) connection electrical leads (48) having a central tube (50) having opening (35) through which gas for heating enters the heater cartridge. The gas exits the tube at far end and is forced to flow over the fins of said heater picking up heat as it travels over the heater fins and enters the space as shown by arrows via internal connection (51). Obvious advantage is to make the whole unit compact, built within the tool or on a simple adapter plate behind the tool (not shown) and minimise external connections and space on factory floor. The heater cartridge is surrounded by insulation (52) thus energy loss is minimised. Cold runner in space (343) when present after moulding first part is removed by runner removal mechanism (not shown) allowing clear passage for gas to enter in space (37).

FIG. 12 we are shown cross section through mould for an article of TIR lens type having varying thickness. Cooling channels are shown as (42, 43 and 44), by way of example being circular in nature. Three thicknesses used for analysis (B-39, D-40, F-41). Coolant is circulated through cooling channels as shown at (42, 43 and 44), for sake of simplicity on both sides of tool, the core and the cavity.

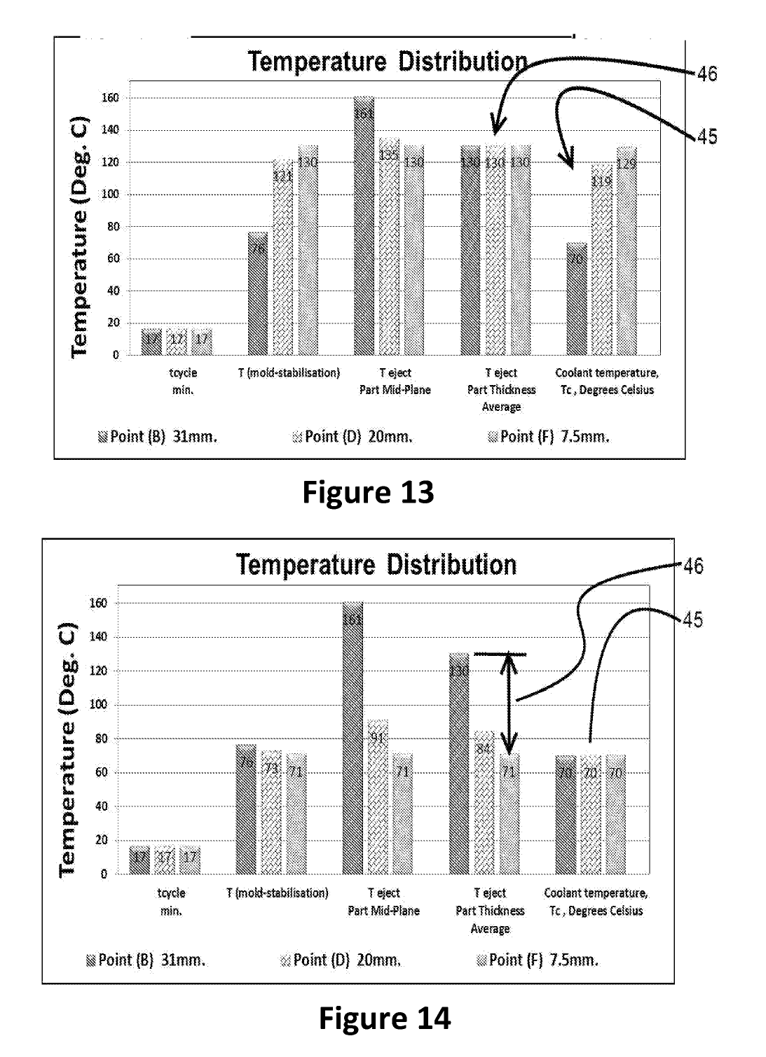

FIG. 13 we are shown temperature distribution through an article of TIR lens type analysed for 3 thickness levels. In this instant the coolant temperature (45) through all the circuits namely (42, 43 and 44) as shown in FIG. 11 is same and it flows through both halves of tool CORE and the CAVITY, and as thin section will cool faster than thick section we note a vast difference in part thickness average temperature (46). This is primary source of internal stress and geometry variation due to differential volumetric shrinkage.

FIG. 14, In this instant the coolant temperature (45) through all the circuits namely (42, 43 and 44) as shown in FIG. 11 is varied and it flows through both sides of tool CORE and the CAVITY, and as thin section will cool faster than thick section, here the coolant temperature in front of thin section has been optimised and made lot warmer compared to that for thick section. This has resulted in identical part thickness average temperature (46). Thus primary source of internal stress and geometry variation due to differential volumetric shrinkage has been eliminated whilst maintaining same cycle time.

Whilst only coolant temperature was shown as variable it was by way of example only and it should be understood here that the same effect could be achieved by varying the distance of cooling channel and or pitch between the cooling channel or varying flow rate or even the type of coolant by itself or combination of any of the factors and is understood to be included without departing from the essential features or the spirit or ambit of the invention.

Whilst by way of example in preceding description only two shot moulding having the first shot overmoulded with the second shot only one side only is described, however the technology should be understood to be applicable to articles having more than 2 layers and more than two moulding steps moulding second layer on both sides of first shot simultaneously, a number of additional layers sequentially moulded on the same or opposite sides or moulding second shot all around encapsulating first shot without departing from the essential features or the spirit or ambit of the invention.

By way of example only the two shot article is described as made of two different materials it should be understood that the two materials could be the same.

Whilst by way of example heating of first shot article before moulding of second article is described in preceding description, cooling of the first shot article before moulding of second article in specific application be understood to be introduced into process flow previously described without departing from the essential features or the spirit or ambit of the invention.

Whilst by way of example in preferred aspect first part and the second part are having permanent bond, when desired same technology could be applied to production of overmoulded parts having non permanent connection without departing from the essential features or the spirit or ambit of the invention.

It should be understood here that above described heater, vacuum connection, internal connections, blocking mechanism and passages could as well be combined with the cold runner removal mechanism and should be obvious to a person versed in the art of tool making.

Whilst the above description includes the preferred embodiments of the invention, it is to be understood that many variations, alterations, modifications, combinations and/or additions may be introduced into process flow previously described without departing from the essential spirit or ambit of the invention.

It will be also understood that where we refer to injection moulding second part in this specification variations including but not limited to lacquer application by injection moulding, for example as paint process replacement, liquid silicone rubber injection overmoulding, integration of injection molding and a reaction molding process, PU skin injection overmoulding, TPU skin injection overmoulding, hard coat application on an overmoulded article by injection moulding, in-mould labeling, rubber curing, extrusion blow moulding combined with insert overmoulding, die casting, glass overmoulding with, for example soft seal are to be included and form part of the invention. It should be further understood that the sequence of moulding could be reversed and second material as described above is moulded first and first material is moulded second without departing from the essential spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features. The reference to any prior art in this specification is not, and should not be taken as, an acknowledgment or any form of suggestion that such prior art forms part of the common general knowledge.

1. A method for manufacture of an overmoulded article wherein: article is made up of at least two parts first part and second part in preferred aspect having permanent bond, either made of same material or optionally moulded out of different materials first material and second material respectively, comprising an injection moulding tool setup having at least two mould cavities, first cavity defining configuration of first part and second cavity defining configuration of second part, the first cavity and the second cavity in preferred aspect are made up of sub inserts making up moulding tool that can be opened at parting line where from either the first part or the overmoulded article can be ejected;
injecting the first material into said first cavity moulding the first part;
at least partially cooling the first part;
exposing at least a portion of surface that is to be overmoulded;
advantageously before the said first part has completely cooled to room temperature, surface temperature of said first part which is to have permanent bond with said second part is altered by application of heat to at least a portion of said surface of the said first part which is so characterized that at end of heating there exists at least three temperature zones in the first part namely zone 1, zone 2 and zone 3, the zone 1 closest to surface of the first part that was heated, the zone 3 near middle of thickness of the said first part and the zone 2 is inter spaced between the zone 1 and the zone 3, temperature in zone 1 is higher than temperature in the zone 2 and temperature in the zone 3 is higher than temperature in the said zone 2;
injecting second material into said second cavity, said second material flowing into said second cavity in contact with at least a portion of the as moulded first part wherein said a portion of said first part effectively defines a passageway and common surface for said second material flowing into said second cavity to form said second part of said overmoulded article;
cooling the moulded article; and
ejecting the overmoulded article from the second cavity.

2. Method for manufacture of the overmoulded article according to claim 1 wherein: article is produced in a two stage moulding tool wherein: the first part is produced by injecting first material into the first cavity;
at least partially cooling the first part;
transferring the first part to an intermediate station wherein exists arrangement for cooling the first part and arrangement for heating the first part and has buffering capacity of at least one first part;
first part is cooled as it traverses through the arrangement for cooling;
advantageously before the first part has completely cooled to room temperature the first part traverses through the arrangement for heating wherein surface temperature of said first part which is to have permanent bond with said second part is altered by application of heat to at least a portion of said surface of the said first part which is so characterized that at end of heating there exists at least three temperature zones in the first part namely zone 1, zone 2 and zone 3, the zone 1 closest to surface of the first part that was heated, the zone 3 near middle of thickness of the said first part and the zone 2 is inter spaced between the zone 1 and the zone 3, temperature in zone 1 is higher than temperature in the zone 2 and temperature in the zone 3 is higher than temperature in the said zone 2;
transferring the so heated first part from the said intermediate station to second cavity; and
injection moulding of the second part thereby manufacturing the overmoulded article.

3. Method for manufacture of the overmoulded article according to claim 1 wherein: the injection moulding setup is having at least two mould cavities, the first cavity and the second cavity wherein the first part is produced by injecting first material into the first cavity;
at least partially cooling the first part;
transferring the first part to second cavity;
advantageously before the said first part has completely cooled to room temperature surface temperature of said first part which is to have permanent bond with said second part is altered by application of heat to at least a portion of said surface of the said first part which is so characterized that at end of heating there exists at least three temperature zones in the first part namely zone 1, zone 2 and zone 3, the zone 1 closest to surface of the first part that was heated, the zone 3 near middle of thickness of the said first part and the zone 2 is inter spaced between the zone 1 and the zone 3, temperature in zone 1 is higher than temperature in the zone 2 and temperature in the zone 3 is higher than temperature in the said zone 2; and
injection moulding of the second part thereby manufacturing the overmoulded article.

4. Method for manufacture of the overmoulded article according to claim 1 wherein: the injection moulding tool setup is having at least two mould cavities, the first cavity and the second cavity so arranged that the first cavity and the second cavity are in flow communication having at least some common surface enabling the first part and the second part to be joined at the said common surface to form the overmoulded article;
the first cavity and the second cavity are initially having blocked flow communication between the first cavity and the second cavity;
wherein the first part is produced by injecting first material into the first cavity;
at least partially cooling the first part;
opening flow communication between said first cavity and second cavity, by way of example only including but not limited to, retracting at least a wall of first cavity that may also form a wall of second cavity; advantageously before the said first part has completely cooled to room temperature surface temperature of said first part which is to have permanent bond with said second part is altered by application of heat to at least a portion of said surface of the said first part which is so characterized that at end of heating there exists at least three temperature zones in the first part namely zone 1, zone 2 and zone 3, the zone 1 closest to surface of the first part that was heated, the zone 3 near middle of thickness of the said first part and the zone 2 is inter spaced between the zone 1 and the zone 3, temperature in zone 1 is higher than temperature in the zone 2 and temperature in the zone 3 is higher than temperature in the said zone 2; and
injection moulding of the second part thereby manufacturing the overmoulded article.

5. Method for manufacture of the overmoulded article according any of preceding claims wherein: advantageously wall temperature of the first cavity and the second cavity is rapidly raised prior to injection of melt and rapidly lowered post injection and process parameters for moulding of the first part and the second part are adapted for fastest possible cycle time without having any regard to temperature required at interface of the first part and the second part, including but not limited to melt temperature, packing pressure, tool surface temperature and cooling time.

6. Method of the at least partially cooling the first part according to any of preceding claims wherein: involves passage of cooling medium through cooling channels built in walls of first cavity.

7. Method of the at least partially cooling the first part according to any of preceding claims wherein: involves passage of cooling medium through cooling channels built in walls of first cavity followed by passage of cooling gas directly in contact with at least a portion of first part.

8. Method of passage of cooling gas according to claim 7 involves passage of cooling gas directly in contact with at least a portion of the first part and exit of cooling gas is through a pressure regulating valve such that predefined back pressure is maintained by the gas in contact with first part.

9. Method of cooling as per claim 2 at the intermediate station wherein:
arrangement for cooling consists of climate controlled refrigerated chamber having humidity control and the first part is cooled, as it traverses through the arrangement for cooling after ejection from first cavity, by combination of radiation to cold chamber walls and by convection to circulating purified cooled gas or air directed at its surface or combination of both modes.

10. Method of cooling as per claim 2 at the intermediate station wherein:
arrangement for cooling consists of climate controlled refrigerated chamber having humidity control and the first part is cooled, as it traverses through the arrangement for cooling after ejection from first cavity, by conduction in contact with atleast one independently movable plate at least from one side of the first part provided within the said chamber so configured that it maintains constant pressure on the first part as it cools and the movable plate is having matching shape as that of first part and is maintained at very low temperatures including but not limited to −52 Deg. C.

11. Method of cooling as per claim 2 at the intermediate station wherein:
arrangement for cooling consists of climate controlled refrigerated chamber having humidity control and the first part is cooled, as it traverses through the arrangement for cooling after ejection from first cavity, by conduction in contact with at least one independently movable plunger at least from one side of the first part provided within the said chamber so configured that it maintains constant pressure on the first part as it cools and the plunger end in contact with first part is having matching shape as that of first part and is provided with atleast one protruding member less than 5 mm. in maximum height that may be integral to the said plunger and said protrusion is generally conical or hemispeherical in shape having generous rounded edges fillets and free of sharp corners and and said plunger and the said protrusion are maintained at very low temperatures including but not limited to −52 Deg. C.

12. A method for manufacture of the overmoulded article according to any of preceding claims wherein: at least partial vacuum is maintained in first cavity and or second cavity during injection of liquefied polymer for moulding of the first part or the second part.

13. Method of maintaining partial vacuum according to claim 12 wherein: at least one connection to a vacuum source from the first cavity and or from the second cavity is configured such that at least one connection to vacuum source at the first cavity and or the second cavity is substantially same as at least one entry point of liquefied polymer melt entering the second cavity, at least some extracted air or gas from the second cavity traverses through a passage that at least partially is in common with passage used by liquefied polymer melt entering the second cavity and junction point between so shared passage and further passage upstream towards vacuum source is provided with a blocking mechanism that allows flow of extracted air or gas to pass through to vacuum source and melt is prevented from entering the further passage upstream towards vacuum source between the melt passage and vacuum source.

14. A method for manufacture of the overmoulded article according to any of preceding claims wherein: positive pressure is maintained in first cavity and or second cavity during injection of liquefied polymer for moulding of the first part or the second part.

15. A method for manufacture of the overmoulded article according to claim 1 wherein: first part is, including but not limited to, a label or an in mould decoration (IMD); transferring said first part to first cavity; altering surface temperature of first part by application of heat at least selectively to at least some portion of surface of first part which is to receive second part bonding at overmoulding step; and overmoulding by injection moulding process.

16. A method for manufacture of the overmoulded article according to claim 1 wherein: first part is, including but not limited to, a label or an in mould decoration (IMD); altering surface temperature of first part by application of heat at least selectively to at least some portion of surface of first part which is to receive second part bonding at overmoulding operation; and the overmoulding is carried out by blow moulding process.

17. A method for manufacture of the overmoulded article according to any of preceding claims wherein: second part injection moulding includes but not limited to application of lacquer, moulding liquid silicone rubber (LSR), moulding thermo plastic urethane (TPU), moulding thermo plastic elastomer (TPE).

18. A method for manufacture of the overmoulded article according to any of preceding claims wherein: second part injection moulding includes but not limited to combination of application of lacquer, moulding liquid silicone rubber (LSR), moulding thermo plastic urethane (TPU), moulding thermo plastic elastomer (TPE) applied simultaneously or separately in a sequenced injection moulding manner.

19. Method of application of heat to first part according to any of preceding claims wherein: heat is applied by a panel configured to deliver heat energy by way of but not limited to heated gas or infrared elements that slides in proximity of second part through second cavity that has been opened at parting line, preheating first shot as well as optionally heating surface of second cavity.

20. Method of application of heat according to claim 19 wherein: heat is applied preferably by passage of heated gas over surface of first part including but not limited to Nitrogen or Carbon Dioxide.

21. Method of application of heat according to claim 20 wherein: heat is applied by passage of heated air over surface of first part.

22. Method of application of heat according to claim 20 wherein: there exists a chamber in moulding tool containing second cavity preferably having external thermal insulation, at a location removed from surface of the second cavity, that receives a heater cartridge, un-heated gas enters the said chamber passes over the heater cartridge picking up heat as it passes and so heated gas is preferably directed to pass through internal passage in moulding tool body in communicable connection with second cavity on to surface of moulded first part raising temperature of the surface of the first part that is to be overmoulded.

23. Method of application of heat according to claim 20 wherein: there exists a compact heater mounted external to moulding tool in communicable connection with second cavity preferably via internal passage in moulding tool body; and un-heated gas enters the said compact heater picking up heat as it passes through it and so heated gas is preferably directed to pass through internal passage in moulding tool body in communicable connection with second cavity on to surface of moulded first part raising temperature of the surface of the first part that is to be overmoulded.

24. Method of supply of gas according to claim 20 wherein: at least one entry point of heated gas to the second cavity and at least one exit point from the second cavity are so arranged that the entry point and exit points are substantially removed from each other and heating gas is preferably made to pass over entire surface of the first part raising temperature of the surface of the first part that is to be overmoulded substantially uniformly and advantageously heating surface of second cavity at same time.

25. Method of supply of gas according to claim 20 wherein: exit of heating gas is restricted by maintaining a gap not exceeding 2 mm. on parting line of the second cavity such that it allows heating gas to escape slowly from the second cavity generally in all directions.

26. Method of supply of gas according to claim 20 wherein: exit of heating gas is restricted by maintaining a gap not exceeding 0.2 mm. on parting line of the second cavity such that it allows heating gas to escape slowly from the second cavity generally in all directions.

27. Method of supply of gas according to claim 20 wherein: exit of heating gas is restricted by maintaining a gap not exceeding 0.05 mm. on parting line of the second cavity such that it allows heating gas to escape slowly from the second cavity generally in all directions.

28. Method of supply of gas according to claim 20 wherein: at least one passage through which gas traverses before entering the second cavity is configured to at least partially share passage used by liquefied polymer melt entering the second cavity such that at least one entry point of heating gas to the second cavity is substantially same as at least one entry point of liquefied polymer melt entering the second cavity and junction point between passage through which gas traverses and melt passage is provided with a blocking mechanism that controls direction of gas and melt flow such that gas is prevented from entering polymer melt upstream towards machine nozzle and melt is prevented from entering further passage upstream towards gas source between the melt passage and gas source.

29. Method of application of heat according to claim 19 wherein: heat is applied by infrared radiation emitted by infrared heater element.

30. Method of application of heat according to claim 29 wherein: heat is applied by infrared radiation emitted by infrared heater element wherein temperature of infrared heating element is predetermined emitting infrared waves at predetermined wavelength band.

31. Method of application of heat according to claim 29 wherein: heat is applied by infrared radiation emitted by surface of second cavity that has been heated to temperature higher than glass transition temperature of the first material or the second material whichever is higher plus at least 10 Deg. C.

32. Method of application of heat according to claim 29 wherein: heat is applied by infrared radiation emitted by surface of second cavity that has been heated to temperature higher than Heat Deflection Temperature at 1.8 MPA (HDT, 1.8 MPA) for the first material or the second material whichever is higher plus at least 10 Deg. C.

33. Method of application of heat according to any of the preceding claims wherein: application of heat is controlled by closed loop feedback of sensing temperature on surface of the first part being heated.

34. Method of application of heat according to any of the preceding claims wherein: application of heat is controlled by setting time.

35. Method of application of heat, according to any of the preceding claims wherein: application of heat is controlled by closed loop feedback of sensing temperature on surface of the first part being heated and set time delay after set temperature has been reached.

36. A method for manufacture of the overmoulded article according any of preceding claims wherein: overmoulded article as a whole is of significance and first part and second part dimensions individually are of no consequence, whole article is divided amongst at least two parts the first part and the second part, dimensions of which are predetermined through numeric simulation such that cycle time estimates for moulding of the first part and that of the second part are essentially equal and process is balanced wherein individual and unique processing conditions are adapted for fastest possible cycle time without having any regard to temperature required at interface of the first part and the second part moulding including but not limited to melt temperature, packing pressure, tool surface temperature and cooling time.

37. A method for manufacture of the overmoulded article according any of preceding claims wherein: mould cavities for the first part and the second part have provision of heat exchange conduits close to and equidistant to moulding surface of mould cavities for the first part and the second part.

38. A method for manufacture of the overmoulded article according any of preceding claims wherein: mould cavities for the first part and or the second part are provided with variable rate of cooling in various portions of mould cavities in accordance to thickness of overmoulded article being cooled in its immediate vicinity, wherein optimal solution comprises one or combination of but not limited to cooling conduits separated in multiple cooling zones, varying distance between the cooling conduits and cavity face in each zone, varying distance between the cooling conduits in each zone, varying tool material in each zone, varying temperature of coolant flowing through each zone, varying flow rate of coolant through each zone and varying the coolant flowing through each zone; and on completion of cooling overmoulded article is cooled to substantially equal part thickness average temperature without regard to thickness of part in immediate vicinity of each of said multiple cooling zones.

39. Method for designing optimal solution for variable cooling according to claim 38 wherein: optimal solution is arrived at through numeric simulation.

40. Method of numeric simulation according to any of preceding claims wherein:
advantageously numeric simulation software used is, but not limited to, UltraCalc developed by www.UltraCool3D.com.

41. A method for manufacture of the overmoulded article according any of preceding claims wherein:transferring the overmoulded article to stress relieving chamber maintained at specific atmosphere having specific temperature and pressure.

42. Method of stress relieving according to claim 41 wherein: transferring the overmoulded article to stress relieving chamber maintained at specific temperature and specific pressure that is higher than atmospheric pressure.

43. Method of stress relieving according to claim 41 wherein: transferring the overmoulded article to stress relieving chamber having controlled cooling rate and may contain specific features including but not limited to being maintained at specific temperature, having pressure that is lower than atmospheric pressure and internal insulation.

44. Method of stress relieving according to claim 41 wherein: transferring the overmoulded article to stress relieving chamber that is maintained with inert gas atmosphere inside of it.

45. Method of stress relieving according to claim 41 wherein: transferring the overmoulded article to stress relieving chamber and energy is delivered to the overmoulded article via infrared radiation.

46. Method of stress relieving according to claim 45 wherein: infrared radiation is characterized such that emitted infrared radiation is confined to predetermined wavelength band specific to material of the second part of said article such that the material of the said second part of said article is substantially opaque within the said predetermined wavelength band.

47. Method of stress relieving according to claim 45 wherein: infrared radiation is characterized such that emitted infrared radiation is confined to predetermined wavelength band specific to material of the second part of said article such that the material of the said second part of said article is substantially transparent within the said predetermined wavelength band allowing energy to pass through and raising temperature in or close to interstitial space between the first part and the second part.

48. A method for manufacture of the overmoulded article according to any of preceding claims wherein: the first material is, chosen based on having high refractivity including but not limited to, Polycarbonate (PC) and the second material is, chosen based on having superior weathering resistance including but not limited to, Poly(methyl methacrylate) (PMMA) and is injection moulded at least on one side of first part or simultaneously on both sides of first part or separately in a sequenced injection moulding manner thus by producing a lens having reduced thickness and having superior weathering resistance and its functional life improved.

49. A method for manufacture of the overmoulded article according to claim 48 wherein: the second material is, chosen based on having superior weathering resistance including but not limited to, UV resistant grade of Poly(methyl methacrylate) (PMMA) having higher UV resistance and is injection moulded at least on one side of first part or simultaneously on both sides of first part or separately in a sequenced injection moulding thus by producing a reduced thickness lens having improved environmental protection including but not limited to improved yellowing resistance and its functional life improved.

50. A method for manufacture of the overmoulded article according to claim 48 wherein: the second cavity is shaped having free form surface having nano features and the second material is, chosen based on having superior weathering resistance including but not limited to, UV grade of Poly(methyl methacrylate) (PMMA) having higher UV resistance and is injection moulded at least on one side of first part or simultaneously on both sides of first part or separately in a sequenced injection moulding thus by producing a reduced thickness lens having nano features and improved environmental protection including but not limited to improved yellowing resistance and its functional life improved.
